(19) United States
(12) Patent Application Publication
(10) Pub. No.: US 2026/0056499 A1
(43) Pub. Date: Feb. 26, 2026

(54) IIMAGE FORMING APPARATUS, AND METHOD AND NON-TRANSITORY COMPUTER-READABLE MEDIUM FOR CONTROLLING SAME

(71) Applicant: Konica Minolta, Inc., Tokyo (JP)

(72) Inventor: Mitsunori NAKAMURA, Tokyo (JP)

(21) Appl. No.: 19/306,571

(22) Filed: Aug. 21, 2025

(30) Foreign Application Priority Data
Aug. 26, 2024 (JP) 2024-144313

(51) Int. Cl. G03G 15/00; H04N 1/00

(52) U.S. Cl. CPC G03G 15/5095; G03G 15/607; G03G 15/6508; G03G 15/6561; H04N 1/00379; H04N 1/00604; H04N 1/00713; G03G 2215/00329; H04N 2201/0094

(57) ABSTRACT

An image forming apparatus includes: a sheet feeder; a reading device that takes a reading of a sheet fed from the sheet feeder; and a controller. The controller performs steps including: for each tray of the sheet feeder, managing sheet information including a reference reading value as a reference for the reading by the reading device; when switching from a first tray to another tray, selecting a second tray such that predetermined items of the sheet information match between the first and second trays; instructing the reading device to take a reading of a sheet fed from the second tray; calculating a correction value of a position of an image to be formed on the sheet fed from the second tray based on a quantity of change in the reading value relative to the reference reading value included in the sheet information of the second tray.

### CROSS REFERENCE TO RELATED APPLICATIONS

This application claims foreign priority to Japanese Patent Application No. 2024-144313, filed Aug. 26, 2024, the disclosure of which is incorporated herein by reference in its entirety.

### BACKGROUND

### Technological Field

The present invention relates to an image forming apparatus, a method of controlling the image forming apparatus, and program for controlling the image forming apparatus.

### Description of Related Art

There is known, as an image forming apparatus provided with a function of making a position of image to be formed on a sheet (hereinafter sometimes referred to as “print position”) constant, an image forming apparatus that performs a print position adjustment every time a sheet feeder or a sheet feed tray is switched. For example, Japanese Unexamined Patent Publication No. 2018-66815 describes an image forming apparatus that prompts a user to perform print position adjustment at the time of switching a sheet feed tray due to running out of sheets or the like. Note that the print position refers to the position of the image with reference to, for example, an end portion of the sheet.

### SUMMARY

### Technical Problem

However, when the print position adjustment is performed at the time of switching a sheet feed tray, the printed material requested by the user cannot be outputted until the processing is completed, so that the productivity may be reduced.

The present invention has been made to solve such a problem, and an object of the present invention is to provide an image forming apparatus capable of suppressing a decrease in productivity that occurs when switching a sheet feed tray due to running out of sheets or the like and outputting a printed material in a state where a print position is appropriately corrected.

### Solution to Problem

To achieve the abovementioned objects, an aspect of the present invention is an image forming apparatus including:
a sheet feeder that includes a plurality of switchable sheet feed trays and feeds a recording medium from one sheet feed tray selected from the plurality of switchable sheet feed trays;
a reading device that takes a reading of a dimension of the recording medium which is fed from the sheet feeder and on which an image has not been formed and outputs a reading value of the reading;
an image forming device that forms an image on the recording medium; and
a controller including a hardware processor and memory,
wherein the controller performs a method including steps of:
   (i) for each of the plurality of switchable sheet feed trays, managing recording medium information of the sheet feed tray by associating the recording medium information with the sheet feed tray, the recording medium information being information on a recording medium stored in the sheet feed tray, the recording medium information configured to include a reference reading value registered as a reference for a reading value to be outputted by the reading device taking a reading of a recording medium fed from the sheet feed tray;
   (ii) when switching from a first sheet feed tray of the plurality of switchable sheet feed trays to a second sheet feed tray of the plurality of switchable sheet feed trays, selecting a sheet feed tray such that predetermined items of the recording medium information associated with the sheet feed tray match the predetermined items of the recording medium information associated with the first sheet feed tray as the second sheet feed tray;
   (iii) instructing the sheet feeder to switch from the first sheet feed tray to the second sheet feed tray;
   (iv) instructing the reading device to take a reading of a dimension of a recording medium fed from the second sheet feed tray as a second-tray reading value and output the second-tray reading value to the controller;
   (v) calculating a correction value of a position of an image to be formed on the recording medium fed from the second sheet feed tray based on a quantity of change in the second-tray reading value relative to the reference reading value registered in the recording medium information associated with the second sheet feed tray; and
   (vi) transmitting the correction value to the image forming device, and
wherein the image forming device forms an image on the recording medium fed from the second sheet feed tray based on the correction value received from the controller.

### BRIEF DESCRIPTION OF THE DRAWINGS

The advantages and features provided by one or more embodiments of the invention will become more fully understood from the detailed description given hereinbelow and the following drawings which are given by way of illustration only, and thus are not intended as a definition of the limits of the present invention:

FIG. 1 is a side view schematically illustrating an outline of an image forming apparatus according to an embodiment.

FIG. 2 is a block diagram illustrating a hardware configuration of the image forming apparatus according to the embodiment.

FIG. 3 is a table illustrating a list of image formation jobs.

FIG. 4 is a block diagram illustrating a part of the function configuration of a central controller according to the embodiment.

FIG. 5 is a table exemplifying items and values of recording medium information (sheet information).

FIG. 6 is a flowchart exemplifying a flow of processing by an image forming apparatus according to a first embodiment and a second embodiment.

FIG. 7 is a flowchart illustrating the flow of processing of switching a sheet feed tray in the first embodiment.

FIG. 8 is a flowchart illustrating the flow of processing of switching a sheet feed tray in a second embodiment.

FIG. 9 is a flowchart exemplifying a flow of processing of registering a reference value.

FIG. 10 is a flowchart exemplifying the flow of processing by an image forming apparatus according to a third embodiment.

FIG. 11 is a flowchart illustrating the flow of pre-checking of registration of reference value.

FIG. 12 is a flowchart illustrating the flow of a print process by a modification of the image forming apparatus according to the third embodiment.

### DETAILED DESCRIPTION OF EMBODIMENTS

Hereinafter, one or more embodiments of the present invention will be described with reference to the drawings. However, the scope of the invention is not limited to the disclosed embodiments.

Herein, the term “switched-from sheet feed tray” is sometimes used to mean a sheet feed tray from which switching is to be made or has been made. Similarly, the term “switched-to sheet feed tray” is sometimes used to mean a sheet feed tray to which switching is to be made or has been made.

### First Embodiment

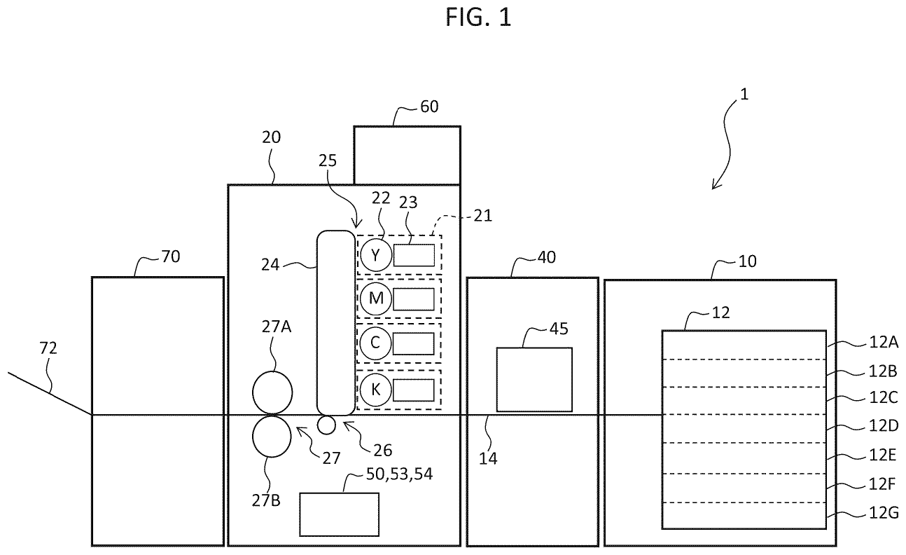

Referring to FIGS. 1 to 7, an image forming apparatus 1 according to a first embodiment will be described.

The image forming apparatus 1 forms an image on a recording medium (hereinafter, sometimes referred to as “sheet”) such as a sheet or an overhead projector (OHP) sheet by electrophotography. The image forming apparatus 1 is, for example, a printing machine, a copier, or a multifunction peripheral. As illustrated in FIG. 1, the image forming apparatus 1 includes a sheet feeder 10, an image forming device 20, a sheet ejector 70, a reading device 40, and a display part 60. The recording medium (sheet) is conveyed on a conveyance path 14 from the sheet feeder 10 on the upstream side to the sheet ejector 70 on the downstream side, and image formation is performed in the image forming device 20. A central controller 50 (controller) that controls the image forming apparatus 1, an auxiliary storage device 53, and a communication interface 54 is arranged in the image forming device 20. Hereinafter, each component of the image forming apparatus 1 will be described.

### Sheet Feeder

The sheet feeder 10 is a device that stores and supplies sheets. The sheet feeder 10 has a plurality of switchable sheet feed trays, and feeds sheets from one sheet feed tray selected from the plurality of sheet feed trays. Here, the sheet feeder 10 includes seven sheet feed trays 12A, 12B, 12C, 12D, 12E, 12F, and 12G, allowing storing sheets with classification. The number of the sheet feed trays 12 is not particularly limited. Note that the image forming apparatus 1 may include a plurality of sheet feeders 10.

The sheet feeder 10 feeds sheets from one selected sheet feed tray 12. The sheet feed tray 12 is able to be freely switched when the sheets run out or the sheets are to be changed or the like, or when a user selects another sheet feed tray 12. The running out of sheets means that the sheets in the selected sheet feed tray 12 run out.

### Image Forming Device

The image forming device 20 is a device that performs image formation on a recording medium based on a position correction value calculated by the below-described image corrector 34. The image forming device 20 includes: image forming units 21 that each form a toner image; a primary transfer section 25 that transfers the toner image onto a belt-like intermediate transfer member 24; a secondary transfer section 26 that transfers the image further onto a recording medium (sheet) from the intermediate transfer member 24; and a fixing section 27 that fixes the toner image transferred onto the sheet. Here, the image forming device 20 includes four image forming units 21 corresponding to four colors of Yellow (Y), Magenta (M), Cyan (C), and Black (K).

Each of the image forming units 21 is a device that forms a toner image on a photosensitive drum 22. Each of the image forming units 21 includes the photosensitive drum 22, on which an electrostatic latent image is formed, and a developing section 23 that converts the electrostatic latent image into a toner image with a developer containing toner. Each of the image forming unit 21 includes, in addition to the developing section 23, a charging section to charge the photosensitive drum 22, an exposure section to perform exposure for forming an electrostatic latent image on the photosensitive drum 22, a cleaning unit to collect residual toner from the photosensitive drum 22, and the like.

At the primary transfer section 25, the toner images of the respective colors Y, M, C, and K are transferred onto the intermediate transfer member 24 so as to be superimposed one on another. At the secondary transfer section 26, the toner images that have become a color image are pressed against the sheet, in order to be transferred thereto. In the fixing section 27, for example, the toner image is fixed to the sheet by performing thermocompression bonding on the sheet between a heating roller 27A and a pressing roller 27B.

### Reading Device

The reading device 40 is a device that reads the dimensions of a recording medium (sheet). The reading device 40 is arranged between the sheet feeder 10 and the image forming device 20 and reads the dimensions of a sheet before image formation and outputs a reading value. The reading value consists of vertical and horizontal dimension values of the sheet, each of which is expressed in units of length (mm) or number of pixels (dot). Even in the case of the same manufacturing lot, the dimension of each sheet varies, which is referred to as cutting variation. The image forming apparatus 1 is capable of correcting this cutting variation and then forming an image.

The reading device 40 takes a reading of the dimensions of the sheet by imaging the sheet being conveyed on the conveyance path 14 with a sensor 45.

The sensor 45 includes an imaging element, which is, for example, a charge coupled device (CCD) sensor used to read an optically reduced image of the target object or a contact image sensor (CIS) used to read the target object at an equal magnification.

### Display Part

The display part 60 is an input/output device that displays information such as the operating status of the image forming apparatus 1 and receives operations and inputs from a user. The display part 60 functions as an interface for the user. The display part 60 includes, for example, a screen of the type of touch screen. The display part 60 is able to receive information for displaying operating status or the like from the central controller 50 and display an occurrence of running out of sheets or the like on the screen to notify the user of the occurrence. The user is allowed to perform selection and switching of the sheet feed tray 12, input the number of sheets to be printed, and input the below-described sheet information and the like, from the display part 60.

### Sheet Ejector

The sheet ejector 70 is a device that ejects sheets sent from the image forming device 20. The sheet ejector 70 is arranged on a lateral side of and downstream of the image forming device 20 and is capable of storing the sheets on which images have been formed in a sheet ejection tray 72. The sheet ejector 70 may include a plurality of sheet ejection trays 72.

Although not illustrated, the image forming apparatus 1 includes a conveyance device that conveys sheets along the conveyance path 14. The conveyance device may have a mechanism to invert the front and back of a sheet having passed through the fixing section 27 and return it to the upstream of the secondary transfer section 26.

### Central Controller

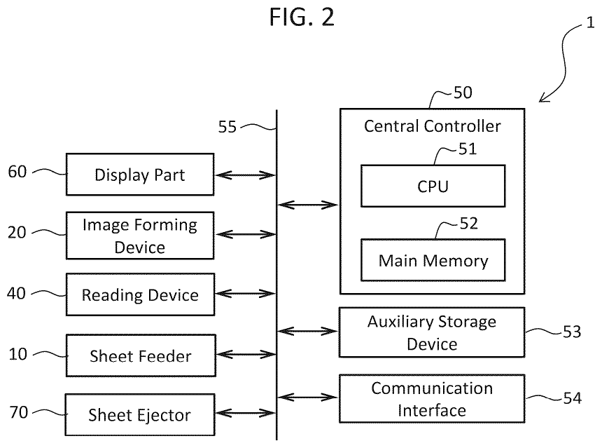

Central controller 50 is a device that controls image forming apparatus 1. As exemplified in FIG. 2, the central controller 50 includes a Central Processing Unit (CPU) 51 (hardware processor) and a main memory 52 (memory) and performs information processing related to control of the image forming apparatus 1. The main memory 52 includes a RAM and a ROM. The central controller 50 is inter-connected to an auxiliary storage device 53 such as a hard disk, a communication interface 54 for connection to the Internet or a Local Area Network (LAN), and other devices of the image forming apparatus 1 via a bus 55.

The central controller 50 receives source image data used as the source data for image formation, generates image formation data, transmits the image formation data to the image forming device 20, and causes the image forming device 20 to execute image formation. The central controller 50 receives job information such as the number of pages and the size of sheets and executes an image formation job (hereinafter simply referred to as a “job”) and controls feeding/conveying/ejecting of sheets.

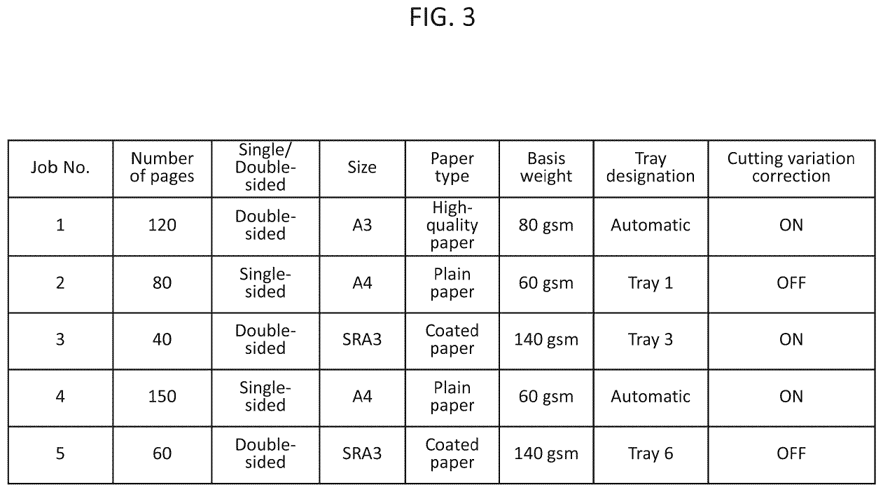

An example of a job list in which the generated jobs are tabulated is illustrated in FIG. 3. Each row in FIG. 3 represents one job, and here, five jobs have been generated. Each job is assigned a number “Job No.” in the order of generation and is managed under the Job No. The jobs are processed one by one in the order of the job list in such a manner that when the processing of the job whose Job No. is 1 is finished, the job whose Job No. is 2 is processed next.

Item “Number of pages” is the number of pages of the image formation data. Item “Single/Double-Sided” specifies whether the image formation is to be made on a single side or double sides of the sheet. Item “Size” is the size of the sheet, indicated by standards such as A3 or A4. Item “Paper type” is the type of the recording medium, indicating the material and/or surface processing such as plain paper or coated paper. Item “Basis weight” is the number of grams of sheet per square meter, and g/m² or gsm is used as the unit. The basis weight is a value representing the thickness if the paper type is the same.

Item “Tray designation” represents a designated sheet feed tray 12. For example, when the user wishes to use a specific sheet, the user may designate a sheet feed tray 12 in which the sheet is stored. The tray designation is made with one of the sheet feed trays 12 being specified, such as “Tray 1”. In a case where the tray designation is “Automatic”, one of the sheet feed trays 12 is selected by the central controller 50 according to the designations of sheet size, paper type, basis weight and the like, and other conditions set by a user in advance. Note that, for example, correspondences may be made such that Tray 1 corresponds to sheet feed tray 12A in FIG. 1 and Tray 2 corresponds to sheet feed tray 12B in FIG. 1. By “Cutting variation correction”, it is possible to designate whether to perform cutting variation correction when forming an image. “ON” specifies that cutting variation correction is to be performed and “OFF” specifies that no cutting variation correction is to be performed.

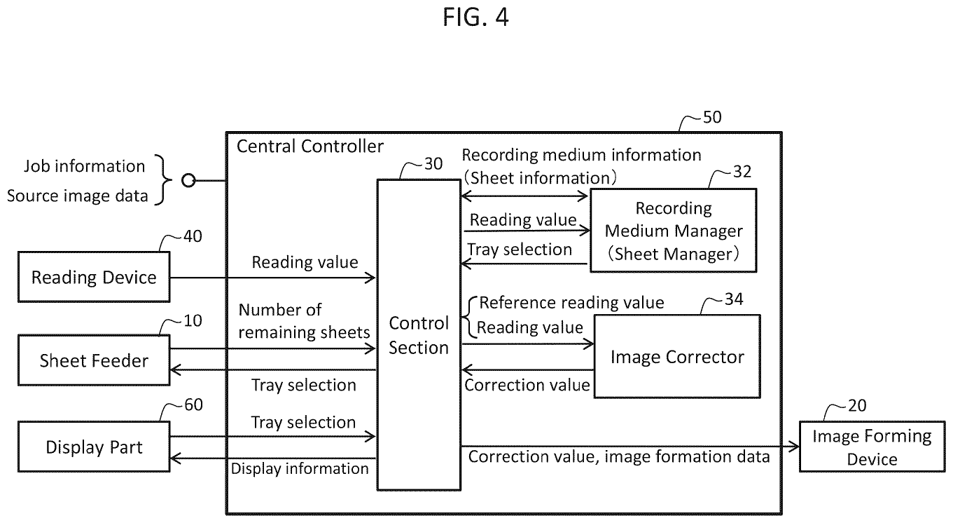

FIG. 4 is a block diagram illustrating a part of the function configuration of the central controller 50. The central controller 50 includes a control section 30, a recording medium manager (sheet manager) 32, and an image corrector 34. The control section 30 is implemented using the CPU 51, communicably connected to the reading device 40, the sheet feeder 10, the display part 60, and the image forming device 20. The control section 30, sheet manager 32, and image corrector 34 are, for example, implemented as software entities running on the computing hardware of the central controller including the CPU 51 and main memory 52.

### Control Section

The control section 30 controls other devices. The control section 30 acquires data from other devices, makes determinations based on predetermined conditions, and transmits signals requesting operations to other devices, to cause the image forming apparatus 1 to function. Note that FIG. 4 illustrates a part of the connections between the control section 30 and other devices, which relates to the adjustment of the print position and the switching of the sheet feeder, omitting the other parts.

The control section 30 instructs the reading device 40 to take a reading of dimensions of a sheet to receive a reading value from the reading device 40.

The control section 30 designates which sheet feed tray the sheet feeder 10 should select and instructs the sheet feeder 10 to switch to the selected sheet feed tray. Then, the control section 30 acquires, from the sheet feeder 10, information such as an occurrence of running out of sheets in the selected sheet feed tray and the number of remaining sheets in each sheet feed tray.

The control section 30 transmits display information regarding the operating status of the image forming apparatus 1, including whether running out of sheets in the sheet feed tray is occurring, to the display part 60 for display. In addition, the control section 30 accepts, from the display part 60, sheet information and information on a sheet feed tray, inputted or designated by a user using the display part 60.

The control section 30 controls image formation by the image forming device 20. The control section 30 transmits, in addition to the signal for controlling the image formation, image formation data which is data of an image to be formed and a correction value for cutting variation correction, to the image forming device 20. Based on the correction value, the image forming device 20 corrects the position at which the image is formed on the recording medium.

The control section 30 passes and receives sheet information to and from the sheet manager 32, issues an instruction to register or update the sheet information to the sheet manager 32, and causes the sheet manager 32 to select a sheet feed tray to which switching is to be made. In addition, the control section 30 passes the reading value to the sheet manager 32 and instructs the sheet manager 32 to register or update the reference reading value.

The control section 30 passes the reference reading value and reading value to the image corrector 34, instructs the image corrector 34 to calculate a correction value, and receives the calculated correction value from the image corrector 34.

### Recording Medium Manager (Sheet Manager)

The recording medium manager (sheet manager) 32 manages recording medium information (sheet information), which is information on recording media (sheets) stored in the sheet feed trays. The sheet manager 32 manages sheet information of a sheet feed tray by associating the sheet information with the sheet feed tray. With this, even when the sheet feed tray is switched to another sheet feed tray, the image forming apparatus 1 is able to perform image formation according to the characteristics of the sheets. The image forming apparatus 1 may be configured such that the sheet information can be input from the outside via the communication interface 54 and can also be input from the display part 60.

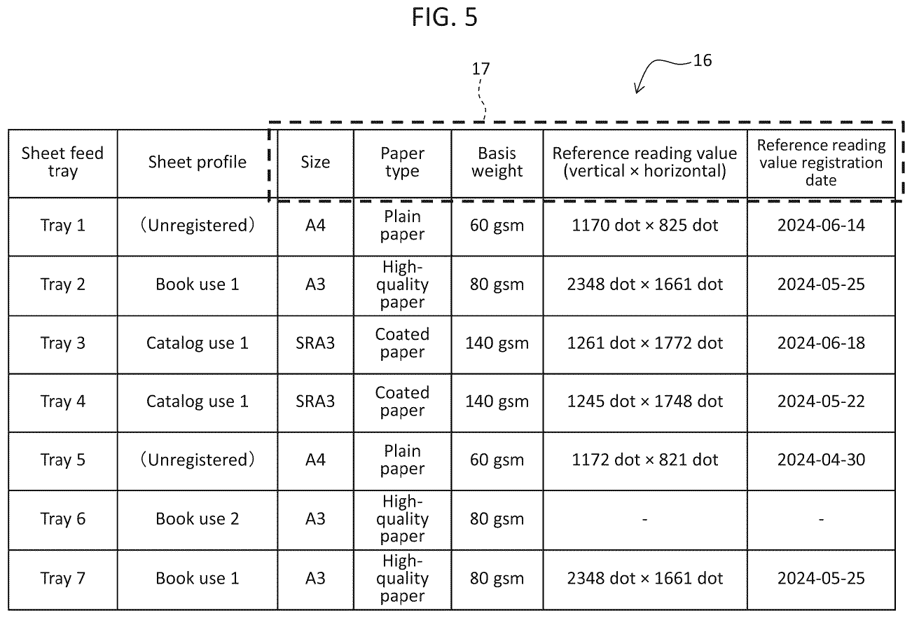

As illustrated in FIG. 5, the sheet information 16 includes items 17, which are information on sheets and in which five items 17 of “Size”, “Paper type”, “Basis weight”, “Reference reading value”, and “Reference reading value registration date” are set and values thereof are registered. The image forming apparatus 1 may be configured so as to allow users to set the number and contents of the items 17.

The “Size”, “Paper type”, and “Basis weight” items have the same meaning as those in the job list. Item “Reference reading value” specifies a value registered as a reference value of the reading value. Like the reading value, the reference reading value consists of vertical and horizontal dimension values of the sheet, each of which is expressed in units of length (mm) or number of pixels (dot). The reference reading value serves as a reference for a print position in cutting variation correction and is used for calculation of a correction value by the image corrector 34.

The image forming apparatus 1 defines the reference reading value as an item of the sheet information. With this, the image forming apparatus 1 is able to manage the reference reading value by associating the reference reading value with a sheet feed tray and maintain the accuracy of cutting variation correction even when the sheet feed tray is switched to another sheet feed tray. Item “Reference reading value registration date” is an item representing the date on which the reference reading value was registered. Note that item “Reference reading value registration date” may include the time at which the reference reading value is registered, to enable the image forming apparatus 1 to display the date and time together.

The sheet manager 32 manages a set of values of the items 17 by associating them with a sheet feed tray. A column of “Sheet profile” is provided on the left side of the items 17. The sheet profile is a name that can be given to a set of values of the items 17 and can be used to identify sheet information. It is possible to apply the same sheet profile to a plurality of sheet feed trays. That is, it is possible to collectively manage different sheet feed trays with a sheet profile by applying the same sheet information of the sheet profile to the different sheet feed trays.

For example, for tray 1, values of “A4”, “Plain paper”, “60 gsm”, “1170 dot×825 dot”, “2024-06-14” are registered for the items of Size, Paper type, Basis weight, Reference reading value, Reference reading value registration date. No sheet profile is registered for Tray 1. Furthermore, for Tray 2, values of “A3”, “High-quality paper”, “80 gsm”, “2348 dot×1661 dot”, “2024-05-25” are registered in the sheet profile named “Book use 1”. The sheet information of the same sheet profile “Book use 1” is also registered for Tray 7, which means the same sheet profile “Book use 1” is applied to the two sheet feed trays.

When running out of sheets occurs in the middle of a job, the sheet feed tray is switched based on the sheet information. In this switching, the sheet manager 32 selects, from the plurality of sheet trays, a sheet feed tray associated with sheet information whose predetermined items match as the target of switching. The predetermined items may be, for example, three items of “Size”, “Paper type”, and “Basis weight”. The same applies to other embodiments. With this, it is possible for the image forming apparatus 1 to retrieve the reference reading value from the sheet information of the sheet feed tray to which switching has been made, which makes it possible to continue the image formation in a state where the print position is appropriately corrected without causing a decrease in productivity. Note the image forming apparatus 1 may be configured to allow users to set the predetermined items in advance.

The reference reading value is used in cutting variation correction. The sheet manager 32 passes, to the control section 30, the reference reading value registered in the sheet information of the sheet feed tray to which switching has been made. On the other hand, for a job with cutting variation correction enabled, when a value is not registered for the reference reading value in the sheet information of the sheet feed tray to which switching has been made, the sheet manager 32 is not able to pass the reference reading value to the control section 30.

In the example illustrated in FIG. 5, the values of reference reading value and reference reading value registration date have not been registered in the sheet profile named “Book use 2”. For example, in switching from Tray 2 with “Book use 1” to Tray 6 with “Book use 2”, the reference reading value has not been registered in the sheet information of the sheet feed tray to which switching has been made. When the reference reading value for the sheet feed tray to which switching has been made has not been registered like this, the sheet manager 32 may register the reference reading value before switching in the sheet information of the sheet feed tray to which switching is to be made and pass the reference reading value to the control section 30. That is, the reference reading value “2348 dot×1661 dot” before switching is passed as the reference reading value of “Book use 2” to the control section 30. With this, the image forming apparatus 1 is able to continue cutting variation correction without suspending the image formation.

Note that the switching of the sheet feed tray may also be performed in a case of changing the type of sheet and may also be performed by a user operation.

### Image Corrector

The image corrector 34 calculates a correction value for the position of an image to be formed on a recording medium (sheet), using a reading value taken by the reading device 40. The image corrector 34 calculates a correction value for the position of the image on the sheet using the reading value.

The position of the image on the sheet can be defined by, for example, the distances from end portions of the sheet. In a case where the sheet has a cutting variation, it is preferable that the image be formed at a position located at fixed distances from end portions of the sheet. The image forming apparatus 1 may be configured such that the user is allowed to freely set how far the distance is from which end portion of the sheet the position should be.

The correction value is calculated based on the quantity of change in the reading value with respect to the reference reading value. The reference reading value is a value retrieved from the sheet information of the sheet feed tray. The reading value is a value to be taken for each sheet by the reading device 40. The reference reading value and the reading value are passed from the control section 30.

The correction value is an adjustment quantity of the print position in the vertical and horizontal directions on a face of the sheet. The cutting variation correction is performed by translating the image without scaling the image so that, for each of the vertical and horizontal directions, a distance Δ from the corresponding end portion of the sheet to the image do not change. Note that the image forming apparatus 1 may be configured to allow users to specify the end portions of the sheet, used as the reference of the print position. The image corrector 34, for each of the vertical and horizontal directions, compares the respective item of the reference reading value with the respective item of the reading value, and when the item of the reading value is smaller than the respective item of the reference reading value, decreases the distance Δ from the respective end portion by, for example, δ1. When the respective item of the reading value is larger than the respective item of the reference reading value, the distance Δ is increased by, for example, δ2. These δ1 and δ2 are the correction value.

The image forming apparatus 1 having the above-described configuration is able to calculate a correction value based on the quantity of change in the reading value from the corresponding reference reading value, compensate for cutting variation for each sheet, and perform image formation. The image forming apparatus 1, when switching from a previous sheet feed tray to a new sheet feed tray, selects the new sheet feed tray such that predetermined items of sheet information match between the previous sheet feed tray and the new sheet feed tray.

The image forming apparatus 1 manages sheet information of a sheet feed tray, in which sheet information a reference reading value is registered as a reference for the reading value, by associating the sheet information with the sheet feed tray. With this, the image forming apparatus 1 is able to retrieve the reference reading value from the sheet information of the sheet feed tray to which switching has been made and output the printed material in a state where the print position is appropriately corrected without causing a decrease in productivity.

In addition, in a case where the reference reading value of the sheet feed tray to which switching has been made has not been registered, the image forming apparatus 1 is able to, by using the reference reading value registered in the sheet information of the sheet feed tray before switching, perform the image formation while continuing the cutting variation correction giving priority to the productivity.

Incidentally, the image forming apparatus 1 may, when not performing the cutting variation correction, set the print position based on the standard values of the dimensions defined as the size of the sheet. In addition, image forming apparatus 1 may allow the user to make settings to, in a case where the cutting variation correction is enabled and the reference reading value is not registered in the sheet feed tray to which switching has been made, continue the image formation by changing the cutting variation correction not to be performed.

### Second Embodiment

Next, a description will be given of an image forming apparatus 1 according to a second embodiment. In the first embodiment, when running out of sheets occurs in the middle of a job and a reference reading value has been registered in the sheet information of the sheet feed tray to which switching has been made, the image formation is continued using the registered reference reading value. On the other hand, in the second embodiment, even when a reference reading value has been registered in the sheet information of the sheet feed tray to which switching has been made, the reference reading value is updated when the registration date is old or when the difference from the reference reading value before switching is large. Except for this point, the second embodiment is the same as the first embodiment.

When running out of sheets occurs in the middle of a job, the sheet manager 32 selects a new sheet feed tray such that predetermined items of sheet information match between the previous sheet feed tray and the new sheet feed tray, and the control section 30 issues to the sheet feeder 10 an instruction to perform switching to the new sheet feed tray. In a case where the reference reading value has not been registered in the sheet information of the sheet feed tray to which switching has been made, the reference reading value of the sheet information before switching is registered in the sheet information of the sheet feed tray to which switching has been made as in the first embodiment.

On the other hand, when a reference reading value has been registered in the sheet information of the sheet feed tray to which switching has been made, the control section 30 calculates a difference in the reference reading value between before switching and after switching. If the difference is equal to or greater than a threshold, the control section 30 performs a “reference value registration”.

The reference value registration is a process that the reading device 40, according to an instruction received from the control section 30, takes a reading of the dimensions of a sheet fed from the sheet feed tray to which switching has been made and outputs a reading value, and then the sheet manager 32 registers the outputted reading value as the reference reading value. The reference reading value for the sheet feed tray to which switching has been made is updated by the reference value registration.

Furthermore, when the elapsed time from the last registration of the reference reading value registered for the sheet feed tray to which switching has been made is equal to or greater than a predetermined time, a reference value registration is performed and the reference reading value for that sheet feed tray is updated. That is, the reference reading value is updated if the difference in the reference reading value between before switching and after switching is equal to or greater than the predetermined threshold or if the elapsed time from the last registration of the reference reading value for the sheet feed tray to which switching has been made is equal to or greater than the predetermined time.

The predetermined threshold is, for example, 1% of the reference reading value before the switching. The predetermined time is, for example, 30 days. The image forming apparatus 1 may be configured such that both the predetermined threshold and the predetermined time may be freely set by the user.

Even if the reference reading value is registered, the correction value may not be correctly calculated when the registration date is old or when the difference from the reference reading value before switching is large. If the image formation is continued while the correction value is not correctly calculated, the quality expected by the user is not obtained, and the productivity is largely reduced due to a re-execution of the job or the like.

In the case of the image forming apparatus 1 according to the second embodiment, when switching from a sheet feed tray (switched-from sheet feed tray) to another sheet feed tray (switched-to sheet feed tray), even when a reference reading value has been registered in the sheet information of the switched-to sheet feed tray, there is cases where the image forming apparatus 1 does not continue image formation with that registered reference reading value. Specifically, when a difference between the reference reading value of the sheet information of the switched-from sheet feed tray and the reference reading value of the sheet information of the switched-to sheet feed tray is equal to or larger than a predetermined threshold or when the elapsed time from the last registration of the reference reading value of the sheet information of the switched-to sheet feed tray is equal to or greater than a predetermined time, the control section 30 instructs the reading device 40 to take a reading of the dimensions of a sheet fed from the switched-to sheet feed tray to output the reading value to the control section 30, and then the control section 30 passes the outputted reading value to the sheet manager 32. Then, the sheet manager 32 updates the reference reading value of the sheet information of the switched-to sheet feed tray with the passed reading value. With this, by using the updated reference reading value, it is possible for the image forming apparatus 1 to maintain the accuracy of the cutting variation correction and to reduce the decrease in productivity.

Note that here, it is assumed that the job is started in a state where an appropriate value is registered for the reference reading value for the switched-from sheet feed tray. The image forming apparatus 1 may be configured to allow the user to give an instruction to update the reference reading value before starting a job or by suspending the job.

### Third Embodiment

Next, a description will be given of an image forming apparatus 1 according to a third embodiment. In the first embodiment, when sheets run out and a reference reading value has not been registered in the sheet information of the sheet feed tray to which switching has been made, the reference reading value before switching is used. In contrast to this, in the third embodiment, before the start of a job, the image forming apparatus 1 checks whether a shortage of sheets would occur and select a sheet feed tray to which switching is to be made (switched-to sheet feed tray) in advance. Then, when no reference reading value has been registered in the sheet information of the switched-to sheet feed tray, a registration of the reference reading value (reference value registration) is performed for the switched-to sheet feed tray. Except for this point, the third embodiment is the same as the first embodiment.

Before starting an image formation job, the control section 30 acquires, from the sheet feeder 10, the number of remaining sheets in a sheet feed tray designated by Tray designation of the job and compares the number of remaining sheets with the number of sheets set in the job. Here, the sheet feed tray designated by Tray designation of the job means a specific sheet feed tray specified by Tray designation or one of the sheet feed trays 12 selected by the central controller 50 based on job items other than Tray designation when Tray designation is “Automatic”. Then, when the number of remaining sheets in the designated sheet feed tray is smaller than the number of sheets in the job, the control section 30 instructs the sheet manager 32 to select in advance a sheet feed tray to which switching is to be made (switched-to sheet feed tray).

The sheet manager 32 selects a sheet feed tray such that predetermined items of sheet information match between the sheet feed tray and the target sheet feed tray as the switched-to sheet feed tray, and notifies the control section 30 of whether a reference reading value is registered in the sheet information of the selected switched-to sheet feed tray.

When no reference reading value has been registered for the selected switched-to sheet feed tray, the control section 30 issues an instruction to perform a “reference value registration” to the sheet information of the selected switched-to sheet feed tray.

The reference value registration is a process that the sheet feeder 10 feeds a sheet from a target sheet feed tray, the reading device 40 takes a reading of the dimensions of the sheet fed from the target sheet feed tray and outputs the reading value, and the sheet manager 32 registers the outputted reading value as the reference reading value of the target sheet feed tray. Note that if a sheet profile has been applied to the target sheet feed tray, the reading value is registered as the reference reading value of the sheet profile. Therefore, if the same sheet profile is applied to a plurality of sheet feed trays, the new reference reading value is also reflected to those sheet feed trays.

The control section 30 performs the reference value registration before starting a job and then starts the job. Then, when the sheet feed tray designated by Tray designation of the job runs out of sheets, the sheet feed tray is switched to the sheet feed tray that has been selected in advance, to continue image formation.

The image forming apparatus 1 according to the third embodiment, prior to starting a job, predicts whether the sheet feed tray would run out of sheets and perform a registration of reference value when a shortage of sheets is predicted. With this, image forming apparatus 1 is able to, even when the sheet feed tray designated by Tray designation of the job runs out of sheets after starting a job, continue the cutting variation correction using the reference reading value registered for the sheet feed tray to which switching has been made, without suspending the image formation. This makes it possible to improve the productivity. Furthermore, it is possible to reduce the user's handling of suspension after the start of the job.

It is to be noted that two or more of the first to third embodiments can be combined. For example, the third embodiment may be modified such that, before starting a job, when a shortage of sheets is predicted and a reference reading value is registered in the sheet information associated with the sheet feed tray to which switching is to be made, the reference reading value is updated using the reference reading value update process of the second embodiment to update the reference reading value in advance before starting the job.

### Processing of Image Forming Apparatus

Next, a description will be given of the flows of the processing performed by the image forming apparatus according to the embodiments. Here, for each of the first to third embodiments, a description will be given of an example of the process (hereinafter also referred to as a “print process”) of forming an image on a sheet.

### Print Process According to First Embodiment

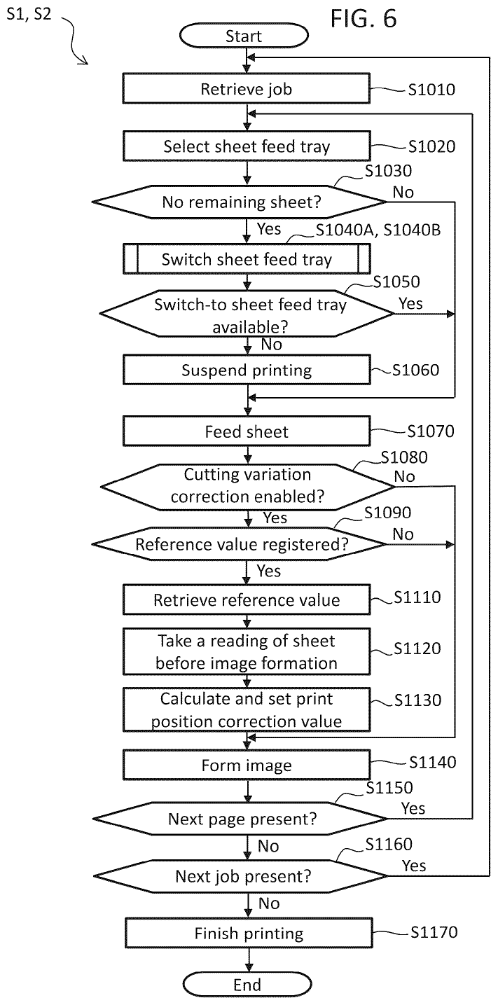

A description will be given of a print process S1 by the image forming apparatus 1 according to the first embodiment. FIG. 6 is a flowchart illustrating the flow of print processes S1 and S2.

### Step S1010: Retrieve Job

First, the control section 30 retrieves the first job from the job list.

### Step S1020: Select Sheet Feed Tray

The control section 30 retrieves page settings from the job and selects a sheet feed tray based on the page settings. Note that the page settings refer to information necessary for performing image formation on sheets, such as sheet size and tray designation.

### Step S1030: Determine if No Remaining Sheet is Present

The control section 30 acquires the quantity of remaining sheets (the number of remaining sheets) in the currently selected sheet feed tray from the sheet feeder 10. When the quantity of remaining sheets is non-zero, the process proceeds to Step S1070. When the quantity of remaining sheets is zero, the processing proceeds to Step S1040A.

### Step S1040A: Switch Sheet Feed Tray

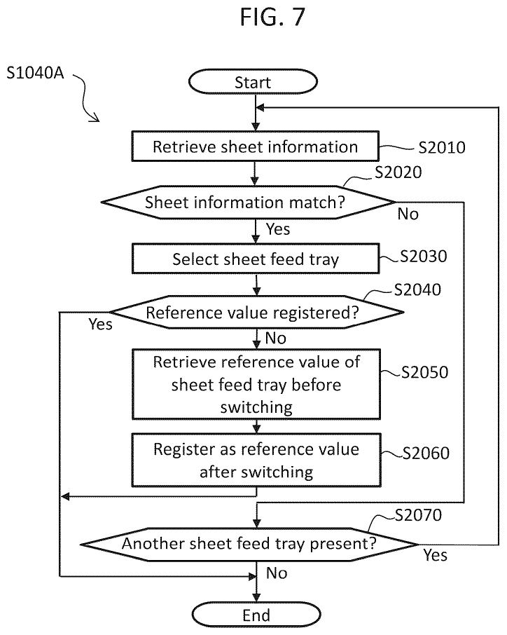

The control section 30 instructs the sheet feeder 10 to “switch sheet feed tray”. The process of “switching sheet feed tray” in the first embodiment is Step S1040A and will be described separately with reference to FIG. 7. When a sheet feed tray is designated as, for example, “Tray 1” in “Tray designation” field of the job, the control section 30 suspends the print processing and displays shortage of sheet on the display part 60. Then, the control section 30 may confirm with the user whether to supply sheet to the sheet feed tray or to switch to another sheet feed tray and then perform the process of “switching sheet feed tray”.

Step S1050: Check Whether a Sheet Feed Tray to which Switching is to be Made is Available

The control section 30 checks whether a sheet feed tray to which switching is to be made has been selected. If such a sheet feed tray has been selected (Yes), the process proceeds to Step S1070, and if not selected (No), the process proceeds to Step S1060.

### Step S1060: Suspend Print Job

The control section 30 displays on the display part 60 that sheets need to be supplied, and suspends the job until sheets are supplied to the sheet feed tray and a non-zero quantity of remaining sheets is detected by the sheet feeder 10.

### Step S1070: Feed Sheets

The control section 30 instructs the sheet feeder 10 to feed a sheet from the selected sheet feed tray. Step S1080: Check whether cutting variation correction is enabled

The control section 30 refers to the job to check whether the cutting variation correction is enabled. If enabled (Yes), the process proceeds to Step S1090, and if disabled (No), the process proceeds to Step S1140.

### Step S1090: Check Whether Reference Value is Registered

The control section 30 makes an inquiry to the sheet manager 32 to confirm whether a reference reading value is registered for the selected sheet feed tray. Note that the sheet manager 32 manages sheet information, which is information on the sheets to be fed, by associating the sheet information with the sheet feed tray. When the reference reading value is registered (Yes), the process proceeds to Step S1110. If not registered (No), the process proceeds to Step S1140 without performing a cutting variation correction.

### Step S1110: Retrieve Reference Value

The control section 30 retrieves the reference reading value registered for the selected sheet feed tray from the sheet manager 32.

### Step S1120: Take a Reading of Sheet Before Image Formation

The control section 30 instructs the reading device 40 to take a reading of the dimensions of a sheet fed for image formation. The reading device 40 responds to the control section 30 with the reading result as a reading value.

### Step S1130: Calculate and Set Print Position Correction Value

The control section 30 notifies the image corrector 34 of the reference reading value and the reading value. The image corrector 34 calculates, from the reference reading value and the reading value, a quantity of change in the reading value (dimension values of the fed sheet) with respect to the reference reading value and calculates a correction value. The control section 30 notifies the image forming device 20 of the correction value, to request correction of the print position.

### Step S1140: Form Image

The control section 30 instructs the image forming device 20 to form an image of the current page on the sheet. When the image forming device 20 is instructed to perform cutting variation correction, the image forming device 20 changes the print position based on the correction value.

### Step S1150: Check Whether a Next Page Exists

The control section 30 refers to the job to check whether a next page exists. If a next page exists (YES), the process proceeds to Step S1020. If a next page does not exist (No), the process proceeds to Step S1160.

### Step S1160: Check Whether a Next Job Exists

The control section 30 refers to the job list to check whether a next job exists. If a next job exists (Yes), the process proceeds to Step S1010. If a next job does not exist (No), the process proceeds to Step S1170.

### Step S1170: Finish Printing

The control section 30 instructs the image forming device 20 to finish printing, so that the print process S1 in FIG. 6 finishes.

### Switching of Sheet Feed Tray According to First Embodiment

A description will be given of the process of switching (Step S1040A) a sheet feed tray in the print process S1. FIG. 7 is a flowchart illustrating the flow of the process of switching a sheet feed tray in the print process S1.

### Step S2010: Retrieve Sheet Information

The sheet manager 32 retrieves the sheet information of a sheet feed tray other than the sheet feed tray from which switching is to be made (sheet feed tray before switching). For example, in the table illustrated in FIG. 5, this retrieval may be performed in order such that the first row is retrieved the first time and the second row is retrieved the second time.

### Step S2020: Determine Whether Sheet Information Match

The sheet manager 32 determines whether the retrieved sheet information matches the sheet information of the sheet feed tray before switching. The sheet manager 32 may be configured to, in order to provide the user a better output product, select a sheet feed tray such that the sheet characteristic items such as a paper type and a basis weight in addition to the size of the sheet are matched as much as possible. Here, the sheet manager 32 makes a determination that they match when the values of the predetermined items match.

An example of the predetermined items are the three items of “Size”, “Paper type”, and “Basis weight”. The image forming apparatus 1 may be configured to allow the user to set the predetermined items.

When a match occurs with the values of predetermined items before switching (Yes), the processing proceeds to Step S2030. If no match occurs (No), the process proceeds to Step S2070.

### Step S2030: Select Sheet Feed Tray

The sheet manager 32 selects the sheet feed tray whose sheet information has been determined as being matched, as the sheet feed tray to which switching is to be made. Then, the control section 30 instructs the sheet feeder 10 to switch to the sheet feed tray selected by the sheet manager 32.

### Step S2040: Check Whether Reference Value is Registered

The sheet manager 32 checks whether a reference reading value is registered in the retrieved sheet information. When a reference reading value is registered (Yes), the process finishes. When no reference reading value is registered (No), the process proceeds to Step S2050.

### Step S2050: Retrieve Reference Value of Sheet Feed Tray Before Switching

The sheet manager 32 retrieves the reference reading value of the sheet feed tray before switching. Step S2060: Register as the reference reading value of the sheet feed tray after switching

The sheet manager 32 registers the retrieved reference reading value of the sheet feed tray before switching as the reference reading value for the sheet feed tray to which switching has been made and finishes the processing. For example, when the sheets run out during execution of Job No. 1 in FIG. 3 on Tray 2 in FIG. 5, the sheet manager 32 selects Tray 6 and registers the reference reading value for tray 2 as the reference reading value in the sheet information associated with Tray 6.

### Step S2070: Check Whether Another Sheet Feed Tray is Present

The sheet manager 32 checks whether there is another sheet feed tray. If there is another sheet feed tray (YES), the process proceeds to Step S2010. If no other sheet feed tray is present (No), the process finishes.

### Print Process According to Second Embodiment

A description will be given of a print process S2 by the image forming apparatus 1 according to the second embodiment. The print process S2 and the print process S1 are different with respect to the processing of switching the sheet feed tray but are the same in other respects.

In view of this, the sheet feed tray switching process (Step S1040B) in the print process S2 will be described, and other descriptions will be omitted. Furthermore, the processing of Step S1040B and the processing of Step S1040A are different only in that the processing for Yes in Step S2040 (Check whether reference value is registered) is different from that of Step S1040A but other processing is common. So the description will be made for the case of Yes in Step S2040.

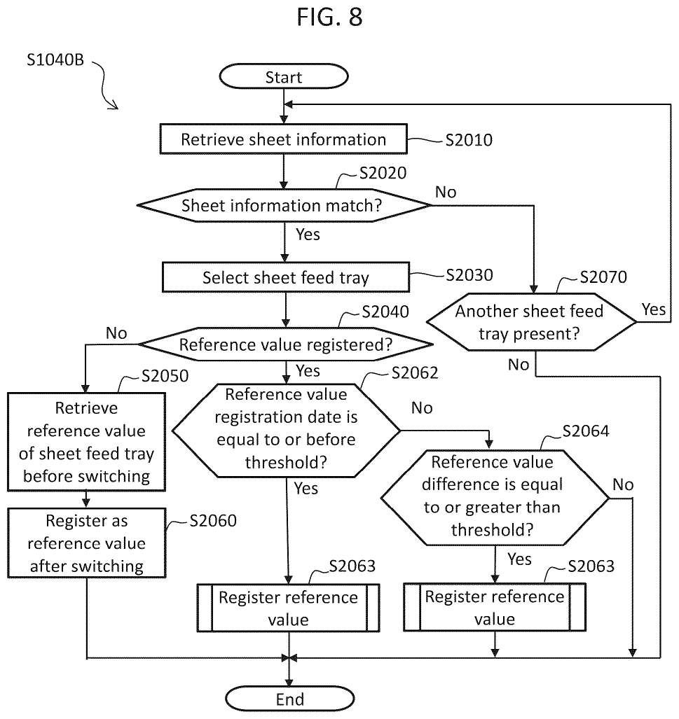

FIG. 8 is a flowchart illustrating the flow of processing of switching a sheet feed tray in the print process S2.

### Step S2040: Check Whether Reference Value is Registered

The sheet manager 32 checks whether a reference reading value is registered in the retrieved sheet information. When registered (Yes), the process proceeds to Step S2062. When not registered (No), the process proceeds to Step S2050.

### Step S2062: Check Whether Reference Value Registration Date is Equal to or Before Threshold

The sheet manager 32 determines whether a predetermined time (e.g., 30 days) or more has elapsed from the registration date of the reference reading value of the sheet feed tray to which switching has been made. If the predetermined time or more has elapsed (Yes), the process proceeds to Step S2063, and if the elapsed time is less than the predetermined time (No), the process proceeds to Step S2064.

As sheets may expand or contract due to changes in environmental conditions (temperature and/or humidity) or the sheets may not be of the same manufacturing lot, it is desirable to discard the reference reading value whose registration date is old. For example, in a case where the current date is 2024-06-17 and the sheet feed tray is switched from Tray 1 to Tray 5 in FIG. 5 during the execution of Job No. 4 in FIG. 3, the reference reading value registration date of Tray 5 is 2024-04-30, which is more than 30 days or earlier than the current date. In this case, the sheet manager 32 discards the reference reading value of Tray 5 and updates the reference reading value of Tray 5 in next Step S2063.

### Step S2063: Register Reference Value

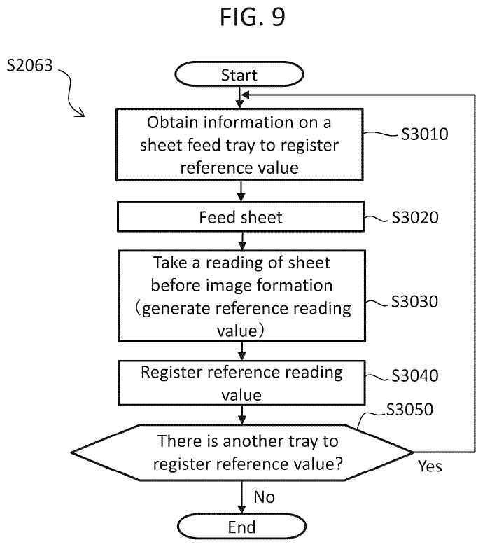

The control section 30 executes a “reference value registration” for the sheet feed tray to which switching is to be made and then finishes the processing. The “reference value registration” will be separately described with reference to FIG. 9.

Step S2064: Check Whether Reference Value Difference is Equal to or Greater than a Threshold

The sheet manager 32 checks whether a difference between the reference reading values before and after the switching is equal to or greater than a predetermined value (for example, 1%). If it is equal to or greater than the predetermined value, the process proceeds to Step S2063. If it is less than the predetermined value, the process finishes.

When the difference between the reference reading values is large, there is a high possibility that the environmental conditions (temperature and/or humidity) are different or the paper type is different, and thus it is desirable to discard the reference reading value. For example, when the sheet feed tray is switched from Tray 3 to Tray 4 in FIG. 5 during the execution of Job No. 3 in FIG. 3, as there is a difference of 1% or more between the reference reading values of the trays with respect to the vertical direction value or the horizontal direction value of the sheet, the reference reading value of Tray 4 is discarded and updated in the next Step S2063.

Note that, in FIG. 8, Step S2062 and Step S2064 may be replaced with each other. That is, in the case of Yes in Step S2040, the process may proceed to Step S2064, and in the case of No in Step S2064, the process may proceed to Step S2062.

### Reference Value Registration

A description will be given of the reference value registration process (Step S2063) in the sheet feed tray switching process (Step S1040B) of the print process S2. FIG. 9 is a flowchart illustrating the flow of reference value registration process.

Step S3010: Obtain Information on the Tray for which Reference Value is to be Registered

The control section 30 obtains information on the sheet feed tray selected as the target of reference value registration (tray to register reference value).

Note that the reference value registration may be executed according to an instruction from the user using the display part 60 or the like. In this case, the information on the tray to register reference value includes a sheet feed tray selected by a user, and the control section 30 instructs the sheet feeder 10 to switch to the selected tray based on the information.

Note that when Step S2063 is performed in the second embodiment or performed as the Reference Value Registration process in Step S4060 of the below-described third embodiment, switching to the sheet feed tray selected as the target of reference value registration has already been performed at this step and thus the control section 30 does not instructs the sheet feeder 10 to switch to the selected tray.

### Step S3020: Feed Sheet

The control section 30 instructs the sheet feeder 10 to feed a sheet from the sheet feed tray.

### Step S3030: Take a Reading of Sheet Before Image Formation (Generate Reference Reading Value)

The control section 30 instructs the reading device 40 to take a reading of the fed sheet. The reading device 40 responds to the control section 30 with a result of reading as a reading value. For example, the numbers of pixels in the vertical and horizontal directions of the sheet read by a CIS or CCD sensor are output as the reading value.

### Step S3040: Register Reference Reading Value

The control section 30 notifies the sheet manager 32 of the reading value to instruct the sheet manager 32 to register the reading value as the reference reading value of the sheet feed tray. At this time, when a sheet profile is applied to the sheet feed tray, the sheet manager 32 also updates the reference reading value of the sheet profile. With this, if the same sheet profile is applied to a plurality of sheet feed trays, the new reference reading value is also reflected to those sheet feed trays.

For example, in FIG. 5, when the reference value is registered for Tray 2, to which sheet profile “Book use 1” is applied, the sheet manager 32 also updates the reference reading value of Tray 7, to which the same sheet profile “Book use 1” is applied.

Step S3050: Check Whether there is Another Tray to Register Reference Value

The control section 30 checks whether there is another sheet feed tray selected as a target of a reference value registration. If so (Yes), the process proceeds to Step S3010, and if not (No), the process finishes.

### Print Process According to Third Embodiment

A description will be given of a print process S3 by the image forming apparatus 1 according to the third embodiment.

The print process S3 and the print process S1 are different in that in the case of the print process S3, a “pre-check of reference value registration” is performed after Step S1010 “Retrieve job” but are the same in other respects.

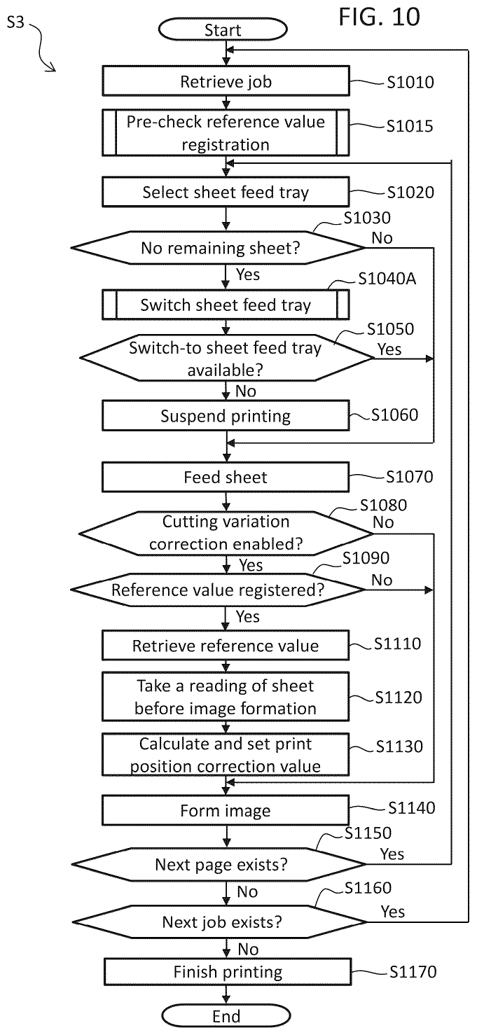

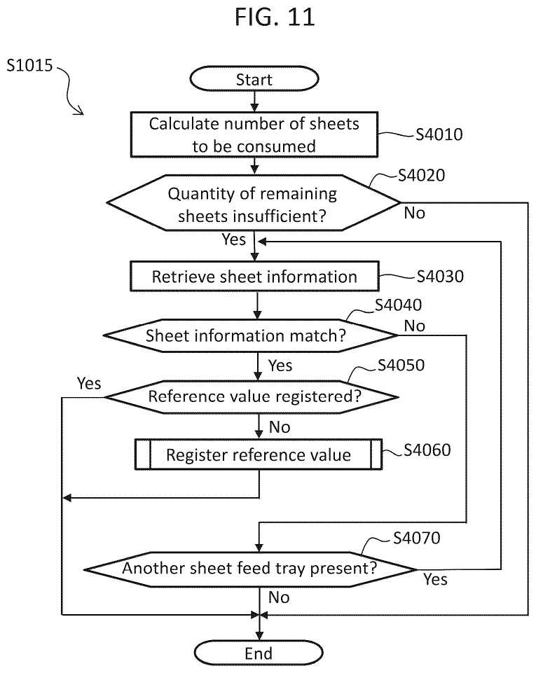

In view of this, the process of “pre-check of reference value registration” (Step S1015) will be described, and other descriptions will be omitted. FIG. 10 is a flowchart illustrating the flow of the print process S3. FIG. 11 is a flowchart illustrating the flow of processing S1015 of pre-checking of registration of reference value.

### Step S4010: Calculate the Number of Sheets to be Consumed

The control section 30 calculates the number of sheets to be consumed based on the number of pages of the current job.

### Step S4020: Check Whether the Quantity of Remaining Sheets is Insufficient

The control section 30 acquires the quantity of remaining sheets from the sheet feeder 10, compares it with the number of the sheets to be consumed, and determines whether the quantity of remaining sheets is insufficient. If the quantity of remaining sheets is insufficient (Yes), the process proceeds to Step S4030, and if the quantity of remaining sheets is not insufficient (No), the process finishes. Note that in a case where the “Tray designation” field of the job is “Automatic”, there is no problem for the process to autonomously proceed to Step S4030 to select the sheet feed tray to which switching is to be made. However, when a specific sheet feed tray is designated in the “Tray designation” field, the control section 30 may confirm with the user whether to switch the sheet feed tray before proceeding.

### Step S4030: Retrieve Sheet Information

The control section 30 instructs the sheet manager 32 to select a sheet feed tray to which switching is to be made after the sheets run out. The sheet manager 32 retrieves the sheet information of the selected sheet feed tray.

### Step S4040: Determine Whether Sheet Information Match

The sheet manager 32 determines whether sheet information match between the sheet feed tray to which switching is to be made and the sheet feed tray before switching. If a match occurs (Yes), the process proceeds to Step S4050. If no match occurs (No), the process proceeds to Step S4070. Here, similarly to Step S2020 “Determine whether sheet information match”, the sheet manager 32 determines a match when predetermined items (for example, three items of “Size”, “Paper type”, and “Basis weight”) match.

### Step S4050: Check Whether Reference Value is Registered

The sheet manager 32 determines whether a reference reading value is registered in the retrieved sheet information. When registered (Yes), the process finishes. When not registered (No), the process proceeds to Step S4060.

### Step S4060: Register Reference Value

The control section 30 instructs the sheet feeder 10 to switch to the sheet feed tray to which switching is to be made. Then, the control section 30 executes a “Reference Value Registration” for the sheet feed tray to which switching is to be made. The processing of this “Reference Value Registration” is the same as Step S2063 “Register reference value”, described for the second embodiment.

### Step S4070: Check Whether Another Sheet Feed Tray is Present

The sheet manager 32 checks whether there is another sheet feed tray. If there is another sheet feed tray (YES), the process proceeds to Step S4030. If no other sheet feed tray is present (No), the processing finishes. Note that if a switched-to sheet feed tray whose sheet information match the sheet information of the sheet feed tray before switching is not found, the print process is suspended until sheets are replenished in Step S1060 “Suspend printing”.

### Modification of Print Process According to Third Embodiment

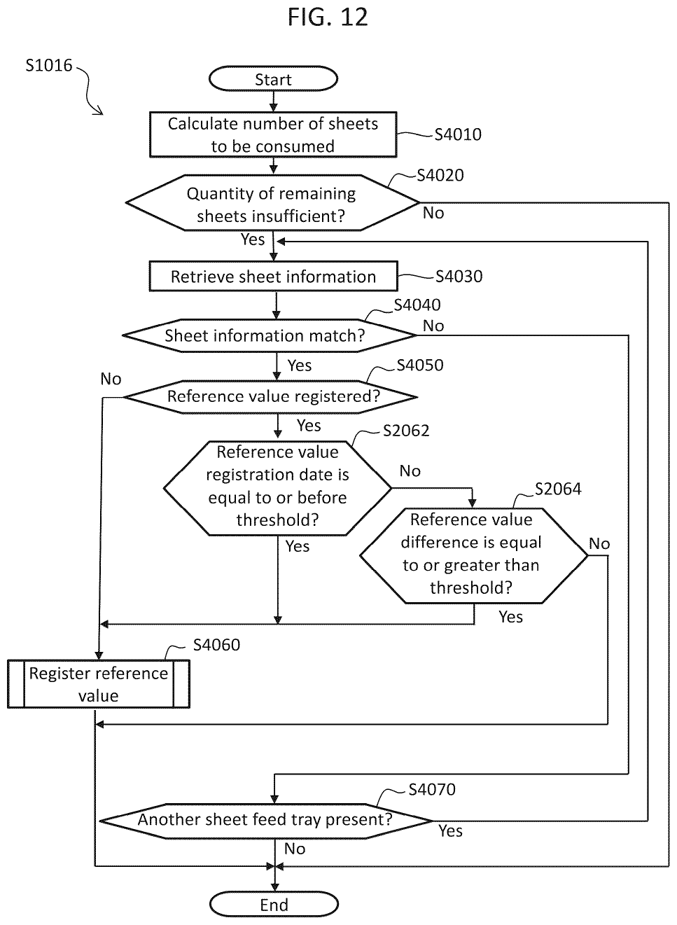

As mentioned earlier, the third embodiment may be modified to perform the reference reading value update process of the second embodiment prior to starting a job. FIG. 12 is a flowchart illustrating Step S1016 of the print process (modified print process S3) according to the modification of the third embodiment. Step S1016 is performed instead of Step S1015 in the print process S3 illustrated in FIG. 10.

The modified print process S3 differs from the print process S3 in that when the determination for Step S4050 (Check whether reference value is registered) is Yes, the reference reading value update process of the second embodiment, including Step S2062 (Check whether reference value registration date is equal to or before threshold), Step S2064 (Check whether reference value difference is equal to or greater than a threshold), and Step S2063 (Register reference value), is performed but other respects are common. As illustrated in FIG. 12, the flow of the processing for Yes in Step S4050 of the modified print process S3 is almost the same as the processing for Yes in Step S2040 of the second embodiment illustrated in FIG. 8. They differ in that the former performs Step S4060, in which switching to the selected sheet feed tray is performed, whereas the latter performs Step S2063, in which the switching is not performed because the switching has been already performed in Step 2030. However, as described above, note that the processing of Step S4060 includes the processing of “Reference Value Registration” by Step S2063.

### Control Method

A control method according to the embodiments is, for example, a method of controlling an image forming apparatus 1 having the hardware configuration according to the first embodiment.

The control method according to the embodiments controls an image forming apparatus including: a sheet feeder that includes a plurality of switchable sheet feed trays and feeds a recording medium from one sheet feed tray selected from the plurality of switchable sheet feed trays; a reading device that takes a reading of a dimension of the recording medium which is fed from the sheet feeder and on which an image has not been formed and outputs a reading value of the reading; an image forming device that forms an image on the recording medium; and a controller including a hardware processor and memory. The control method is to be performed by the controller and includes steps of:
(i) for each of the plurality of switchable sheet feed trays, managing recording medium information of the sheet feed tray by associating the recording medium information with the sheet feed tray, the recording medium information being information on a recording medium stored in the sheet feed tray, the recording medium information configured to include a reference reading value registered as a reference for a reading value to be outputted by the reading device taking a reading of a recording medium fed from the sheet feed tray;
(ii) when switching from a first sheet feed tray of the plurality of switchable sheet feed trays to a second sheet feed tray of the plurality of switchable sheet feed trays, selecting a sheet feed tray such that predetermined items of the recording medium information associated with the sheet feed tray match the predetermined items of the recording medium information associated with the first sheet feed tray as the second sheet feed tray;
(iii) instructing the sheet feeder to switch from the first sheet feed tray to the second sheet feed tray;
(iv) instructing the reading device to take a reading of a dimension of a recording medium fed from the second sheet feed tray as a second-tray reading value and output the second-tray reading value to the controller;
(v) calculating a correction value of a position of an image to be formed on the recording medium fed from the second sheet feed tray based on a quantity of change in the second-tray reading value relative to the reference reading value registered in the recording medium information associated with the second sheet feed tray; and
(vi) controlling the image forming device to form an image on the recording medium fed from the second sheet feed tray based on the calculated correction value.

In the control method according to the embodiments, the step (v) may include a step of, when the reference reading value to be registered in the recording medium information associated with the second sheet feed tray has not been registered, calculating the correction value using the reference reading value registered in the recording medium information associated with the first sheet feed tray.

The control method according to the embodiments may further include a step of:
when a difference between the reference reading value registered in the recording medium information associated with the first sheet feed tray and the reference reading value registered in the recording medium information associated with the second sheet feed tray is equal to or greater than a predetermined threshold or
when an elapsed time since registration of the reference reading value registered in the recording medium information associated with the second sheet feed tray is equal to or longer than a predetermined time,
   updating the reference reading value registered in the recording medium information associated with the second sheet feed tray with the second-tray reading value.

The control method according to the embodiments may further include steps of, prior to starting a job of forming an image:
predicting whether a shortage of recording media in the first sheet feed tray will occur during the job, based on a quantity of remaining recording media in the first sheet feed tray; and
if the shortage of recording media is predicted,
   by the step (ii), selecting the second sheet feed tray, and
   if the reference reading value to be registered in the recording medium information associated with the selected second sheet feed tray has not been registered, performing the steps (iii) and (iv) to receive the second-tray reading value from the reading device and registering the received second-tray reading value as the reference reading value in the recording medium information associated with the selected second sheet feed tray.

The control method according to the embodiments may further include steps of, prior to starting a job of forming an image:
predicting whether a shortage of recording media in the first sheet feed tray will occur during the job, based on a quantity of remaining recording media in the first sheet feed tray; and
if the shortage of recording media is predicted,
   by the step (ii), selecting the second sheet feed tray, and
   when a difference between the reference reading value registered in the recording medium information associated with the first sheet feed tray and the reference reading value registered in the recording medium information associated with the second sheet feed tray is equal to or greater than a predetermined threshold or
   when an elapsed time since registration of the reference reading value registered in the recording medium information associated with the second sheet feed tray is equal to or longer than a predetermined time,
   performing the steps (iii) and (iv) to receive the second-tray reading value from the reading device and updating the reference reading value registered in the recording medium information associated with the second sheet feed tray with the second-tray reading value.

### Computer Program

A computer program according to the embodiments is, for example, a computer program that, when executed by the central controller 50 of the image forming apparatus 1 according to the first embodiment, causes the central controller 50 to perform the control methods described above.

A computer that has loaded the computer program according to the embodiments may serve as the central controller 50 of the image forming apparatus 1 according to the embodiments.

The computer program according to the embodiments may be stored in a non-transitory computer-readable recording medium and delivered.

Although embodiments of the present invention and modifications of the embodiments have been described and illustrated in detail, the disclosed embodiments and modifications are made for purposes of illustration and example only and not limitation. The scope of the present invention should be interpreted by the terms of the appended claims.

1. An image forming apparatus comprising:
a sheet feeder that includes a plurality of switchable sheet feed trays and feeds a recording medium from one sheet feed tray selected from the plurality of switchable sheet feed trays;
a reading device that takes a reading of a dimension of the recording medium which is fed from the sheet feeder and on which an image has not been formed and outputs a reading value of the reading;
an image forming device that forms an image on the recording medium; and
a controller including a hardware processor and memory,
wherein the controller performs a method comprising steps of:
(i) for each of the plurality of switchable sheet feed trays, managing recording medium information of the sheet feed tray by associating the recording medium information with the sheet feed tray, the recording medium information being information on a recording medium stored in the sheet feed tray, the recording medium information configured to include a reference reading value registered as a reference for a reading value to be outputted by the reading device taking a reading of a recording medium fed from the sheet feed tray;
(ii) when switching from a first sheet feed tray of the plurality of switchable sheet feed trays to a second sheet feed tray of the plurality of switchable sheet feed trays, selecting a sheet feed tray such that predetermined items of the recording medium information associated with the sheet feed tray match the predetermined items of the recording medium information associated with the first sheet feed tray as the second sheet feed tray;
(iii) instructing the sheet feeder to switch from the first sheet feed tray to the second sheet feed tray;
(iv) instructing the reading device to take a reading of a dimension of a recording medium fed from the second sheet feed tray as a second-tray reading value and output the second-tray reading value to the controller;
(v) calculating a correction value of a position of an image to be formed on the recording medium fed from the second sheet feed tray based on a quantity of change in the second-tray reading value relative to the reference reading value registered in the recording medium information associated with the second sheet feed tray; and
(vi) transmitting the correction value to the image forming device, and
wherein the image forming device forms an image on the recording medium fed from the second sheet feed tray based on the correction value received from the controller.

2. The image forming apparatus according to claim 1,
wherein the step (v) comprises a step of, when the reference reading value to be registered in the recording medium information associated with the second sheet feed tray has not been registered, calculating the correction value using the reference reading value registered in the recording medium information associated with the first sheet feed tray.

3. The image forming apparatus according to claim 1,
wherein the method further comprises a step of:
when a difference between the reference reading value registered in the recording medium information associated with the first sheet feed tray and the reference reading value registered in the recording medium information associated with the second sheet feed tray is equal to or greater than a predetermined threshold,
updating the reference reading value registered in the recording medium information associated with the second sheet feed tray with the second-tray reading value.

4. The image forming apparatus according to claim 1,
wherein the method further comprises steps of, prior to starting a job of forming an image:
predicting whether a shortage of recording media in the first sheet feed tray will occur during the job, based on a quantity of remaining recording media in the first sheet feed tray; and
if the shortage of recording media is predicted,
by the step (ii), selecting the second sheet feed tray, and
when a difference between the reference reading value registered in the recording medium information associated with the first sheet feed tray and the reference reading value registered in the recording medium information associated with the second sheet feed tray is equal to or greater than a predetermined threshold, performing the steps (iii) and (iv) to receive the second-tray reading value from the reading device and updating the reference reading value registered in the recording medium information associated with the second sheet feed tray with the second-tray reading value.

5. The image forming apparatus according to claim 1,
wherein the method further comprises a step of:
when an elapsed time since registration of the reference reading value registered in the recording medium information associated with the second sheet feed tray is equal to or longer than a predetermined time,
updating the reference reading value registered in the recording medium information associated with the second sheet feed tray with the second-tray reading value.

6. The image forming apparatus according to claim 1,
wherein the method further comprises steps of, prior to starting a job of forming an image:
predicting whether a shortage of recording media in the first sheet feed tray will occur during the job, based on a quantity of remaining recording media in the first sheet feed tray; and
if the shortage of recording media is predicted,
by the step (ii), selecting the second sheet feed tray, and
when an elapsed time since registration of the reference reading value registered in the recording medium information associated with the second sheet feed tray is equal to or longer than a predetermined time, performing the steps (iii) and (iv) to receive the second-tray reading value from the reading device and updating the reference reading value registered in the recording medium information associated with the second sheet feed tray with the second-tray reading value.

7. The image forming apparatus according to claim 1,
wherein the method further comprises steps of, prior to starting a job of forming an image:
predicting whether a shortage of recording media in the first sheet feed tray will occur during the job, based on a quantity of remaining recording media in the first sheet feed tray; and
if the shortage of recording media is predicted,
by the step (ii), selecting the second sheet feed tray, and
if the reference reading value to be registered in the recording medium information associated with the selected second sheet feed tray has not been registered, performing the steps (iii) and (iv) to receive the second-tray reading value from the reading device and registering the received second-tray reading value as the reference reading value in the recording medium information associated with the selected second sheet feed tray.

8. The image forming apparatus according to claim 1,
wherein the predetermined items of the recording medium information include a type, a basis weight, and a size of recording media stored in the corresponding sheet feed tray.

9. A method of controlling an image forming apparatus including: a sheet feeder that includes a plurality of switchable sheet feed trays and feeds a recording medium from one sheet feed tray selected from the plurality of switchable sheet feed trays; a reading device that takes a reading of a dimension of the recording medium which is fed from the sheet feeder and on which an image has not been formed and outputs a reading value of the reading; an image forming device that forms an image on the recording medium; and a controller including a hardware processor and memory, the method comprising steps of, by the controller:
for each of the plurality of switchable sheet feed trays, managing recording medium information of the sheet feed tray by associating the recording medium information with the sheet feed tray, the recording medium information being information on a recording medium stored in the sheet feed tray, the recording medium information configured to include a reference reading value registered as a reference for a reading value to be outputted by the reading device taking a reading of a recording medium fed from the sheet feed tray;
when switching from a first sheet feed tray of the plurality of switchable sheet feed trays to a second sheet feed tray of the plurality of switchable sheet feed trays, selecting a sheet feed tray such that predetermined items of the recording medium information associated with the sheet feed tray match the predetermined items of the recording medium information associated with the first sheet feed tray as the second sheet feed tray;
instructing the sheet feeder to switch from the first sheet feed tray to the second sheet feed tray;
instructing the reading device to take a reading of a dimension of a recording medium fed from the second sheet feed tray as a second-tray reading value and output the second-tray reading value to the controller;
calculating a correction value of a position of an image to be formed on the recording medium fed from the second sheet feed tray based on a quantity of change in the second-tray reading value relative to the reference reading value registered in the recording medium information associated with the second sheet feed tray; and
controlling the image forming device to form an image on the recording medium fed from the second sheet feed tray based on the calculated correction value.

10. A non-transitory computer-readable storage medium storing a computer program that, when executed by a controller including a hardware processor and memory, causes the controller to perform the method according to claim 9.
